(19) United States
(12) Patent Application Publication
(10) Pub. No.: US 2009/0306811 A1
(43) Pub. Date: Dec. 10, 2009

(54) BALL GRID ARRAY CLEANING SYSTEM

(75) Inventor: Carol E. Gregg, Mesquite, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/471,077

(22) Filed: May 22, 2009

Related U.S. Application Data
(60) Provisional application No. 61/059,511, filed on Jun. 6, 2008.

(51) Int. Cl. G06F 19/00

(52) U.S. Cl. 700/159

(57) ABSTRACT

In certain embodiments, a system for cleaning ball grid arrays is provided. The system may include a platform upon which an integrated circuit is mounted. The integrated circuit may have a plurality of terminals arranged in a ball grid array pattern on a surface of the integrated circuit. The system also includes a machining bit and a computer system. The computer system may store the ball grid array pattern and a topographic map of the surface of the integrated circuit and control the machining bit such that the machining bit removes excess material from the plurality of terminals based at least in part upon the ball grid array pattern and the topographical map.

### CROSS-REFERENCE TO RELATED APPLICATION

This application claims the benefit of priority under 35 U.S.C. §119(e) of U.S. Provisional Application 61/059,511 filed Jun. 6, 2008.

### TECHNICAL FIELD OF THE INVENTION

This disclosure generally relates to integrated circuit assembly techniques, and more particularly, to a cleaning system for integrated circuits having a ball grid array and method of using the same.

### BACKGROUND OF THE INVENTION

Relatively complex integrated circuits (ICs) are often configured with numerous terminals. To enhance packaging density, terminals of integrated circuits may be configured in an array. Integrated circuits may be configured in a pin grid array (PGA) in which terminals may be pins that are adapted to protrude through holes in a substrate, such as a circuit board, or ball grid array (BGA) in which terminals have a surface for electrical connection to a surface of the substrate.

Removal of an integrated circuit from a circuit board typically leaves excess solder, resin, or other debris that may hinder its assembly onto another circuit board. Known cleaning techniques for this excess material include a manual process of removing excess solder using hand tools, such as solder-wicks or solder-suckers. Because ball grid arrays may have numerous terminals, this process may present an arduously long task. Removal and cleaning the material from the terminals manually can lead to repetitive motion injuries for workers. Manual removal of the excess material also leads to material that may not be uniform in height or topography.

### SUMMARY OF THE INVENTION

In accordance with the present invention, the disadvantages and problems associated with ball grid array cleaning systems have been substantially reduced or eliminated.

In certain embodiments, a system for cleaning ball grid arrays is provided. The system may include a platform upon which an integrated circuit is mounted. The integrated circuit may have a plurality of terminals arranged in a ball grid array pattern on a surface of the integrated circuit. The system also includes a machining bit and a computer system. The computer system may store the ball grid array pattern and a topographic map of the surface of the integrated circuit and control the machining bit such that the machining bit removes excess material from the plurality of terminals based at least in part upon the ball grid array pattern and the topographical map.

In certain embodiments a method for cleaning ball grid arrays is provided. The method includes receiving an integrated circuit on a platform coupled to a manufacturing tool wherein the integrated circuit has a plurality of terminals arranged in a ball grid array pattern on a surface of the integrated circuit, and wherein the manufacturing tool further comprises a machining bit that is movable with respect to the platform. The method also includes storing the ball grid array pattern and a topographic map of the surface of the integrated circuit in a computer system that controls the manufacturing tool. The method concludes by moving the machining bit, such that the machining bit removes excess material from the plurality of terminals based at least in part upon the ball grid array pattern and the topographical map.

Technical advantages of certain embodiments of the present invention include reduction of repetitive motion injuries for workers removing excess material, the ability to achieve substantially uniform height of material on an integrated circuit to provide good electrical connections, and substantial savings in time and effort to reuse integrated circuits removed from a circuit board. Other technical advantages of the present invention will be readily apparent to one skilled in the art from the following figures, descriptions, and claims. Additionally, while specific advantages have been enumerated above, various embodiments may include all, some, or none of the enumerated advantages. The following technical advantages may be achieved by some or all of the embodiments of the present invention.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a block diagram illustrating a ball grid array cleaning system;

FIG. 2 illustrates an overhead view of a ball grid array on an integrated circuit;

FIG. 3a illustrates a side view of a ball grid array on an integrated circuit;

FIG. 3b illustrates a topographical map of a ball grid array on the integrated circuit of FIG. 3a;

FIG. 4a illustrates a side view of a ball grid array after removal of excess material;

FIG. 4b illustrates a topographical map of the ball grid array of FIG. 4a; and

FIG. 5 is a flowchart describing a series of actions that may be performed by the ball grid array cleaning system.

### DETAILED DESCRIPTION OF THE INVENTION

Integrated circuits having terminals arranged in a ball grid array may provide several advantages. For example, these terminals may be relatively easier to assemble on substrates, such as circuit boards, than pin grid array (PGA) devices due to insertion problems associated with placement of numerous pins through a corresponding numerous quantity of holes. Integrated circuits incorporating a ball grid array suffer, however, in that the material on the terminals should be relatively co-planar with one another to form a good electrical connection to a printed circuit board or other components during manufacture.

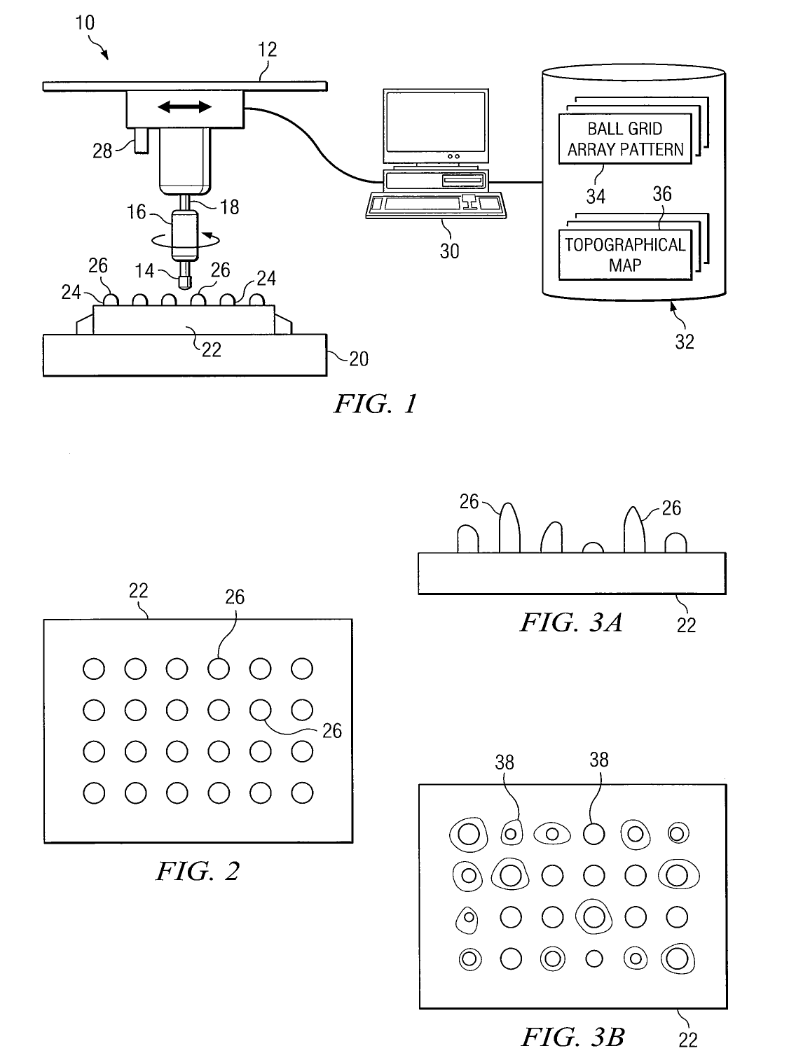

FIG. 1 shows one embodiment of a ball grid array cleaning system 10 that may be used to clean material deposited on terminals arranged in a ball grid array. Ball grid array cleaning system 10 includes a computer-aided manufacturing tool 12 that is configured with a machining bit 14. Machining bit 14 may be coupled to computer-aided manufacturing tool 12 via collar 16 and a rotating shank 18. Computer-aided manufacturing tool 12 may have a platform 20 for temporarily mounting an integrated circuit 22 having terminals 24 arranged in a ball grid array. Terminals 24 may have material 26 deposited on the terminals 24. Computer-aided manufacturing tool 12 may also have a distance measuring system 28. Computer-aided manufacturing tool 12 may also have a computer 30 with storage device 32 for storing ball grid array patterns 34 and topographical maps 36. Computer 30 may selectively control machining bit 14 with respect to the platform 20 in response to ball grid array patterns 34 and/or topographical maps 36. Computer-aided manufacturing tool 12 moves machining bit 14 over the material 26 of terminals 24 to clean the terminals 24 of excess material 26, such as solder, resin, or other debris. Alternatively, computer-aided manufacturing tool 12 could move the platform 20 so that the material 26 are moved in contact with machining bit 14.

Computer-aided manufacturing tool 12 may include any type of device that provides a machining action under computer control. In one embodiment, machining bit 14 is configured on a rotating shank 18 of computer-aided manufacturing tool 12 such that the abrasive action to clean terminals 24 is provided by a rotating motion of machining bit 14. In another embodiment, computer-aided manufacturing tool 12 is an automated adhesive dispenser that is typically used to dispense adhesive onto substrates, such as circuit boards. The automated adhesive dispenser is a commonly used type of computer-aided manufacturing tool 12 in manufacturing and relatively large-scale maintenance operations of circuit boards. In this embodiment, machining bit 14 may be attached to or replace the dispenser nozzle on the automated adhesive dispenser. Thus, use of an automated adhesive dispenser may alleviate the need for a computer-aided manufacturing tool 12 that may be dedicated to one or a relatively few uses in some embodiments.

Collar 16 may mechanically interconnect rotating shank 18 of computer-aided manufacturing tool 12 to any suitable type of machining bit 14. A machining bit 14 that may be used with a DREMEL rotary tool, available from the Robert Bosch Tool Corporation, located in Mount Prospect, Ill. is one example of numerous types of machining bits 14 that may be suitable for cleaning material 26 from terminals 22. Machining bit 14 and rotating shank 18 may be secured to collar 16 using screws inserted through holes in collar 16.

Platform 20 may be attached to computer-aided manufacturing tool 12 or may be separate from computer-aided manufacturing tool 12. Integrated circuit 22 may be mounted or otherwise positioned on platform 20 to hold integrated circuit 22 in place. Integrated circuit 22 may be of any type of circuit including, without limitation, circuits manufactured on the surface of a thin substrate of semiconductor material or individual semiconductor devices, as well as passive components, bonded to a substrate or circuit board. Integrated circuit may have a plurality of terminals 24. These terminals 24 provide electrical connection points to the integrated circuit with external components. Each terminal 24 may have material 26 deposited on the terminal 24 in order to provide these electrical connections to external components.

Distance measuring system 28 may be any suitable system for measuring distance from a point on the surface of integrated circuit 22 to a point on computer-aided manufacturing tool 12, such as the tip of machining bit 14. Distance measuring system 28 may be a laser based system, a sonic based system, or other system for measuring distance. Distance measuring system 28 may be integrated with or separate from computer-aided manufacturing tool 12. Distance measuring system 28 may take measurements from a plurality of locations on the surface on integrated circuit 22. For example distance measuring system 28 may measure multiple points on each of terminals 24 to measure the height and topography of material 26 on terminals 24 for an integrated circuit 22. Data collected with distance measuring system 28 may be used by computer 30 to create a topographical map 36 of the surface of the particular integrated circuit 22 that is having excess material 26 removed. Topographical map 36 may be used to determine the amount of excess material 26 to remove from terminals 24. Storage device 32 may store topographical map 36. Additionally, distance measuring system 28 may provide data to help control the distance machining bit 14 is from the surface of integrated circuit 22 to ensure the proper height of material 26 on terminals 24 after removal of excess material 26.

Computer 30 may be one or more general purpose computers, and may include one or more PCs, workstations, Unix-based computers, server computers, a server pool, or any other suitable devices. Computer 30 may include any suitable combination of software, firmware, hardware, and any other suitable components. Computer may include one or more processors and one or more memory modules. Processors may include one or more microprocessors, controllers, or any other suitable computing devices or resources. Processors may work, either alone or with other components of computer 30 to provide the functionality of computer 30. Each memory module may take the form of volatile or non-volatile memory including, without limitation, magnetic media, optical media, random access memory (RAM), read-only memory (ROM), removable media, or any other suitable memory component. Computer 30 may be integrated with or separate from computer-aided manufacturing tool 12.

Storage device 32 may refer to any suitable device operable for storing data and instructions. Storage device 32 may include, for example, a magnetic disk, flash memory, optical disk, or other suitable data storage device. Storage device 32 may be separate from or part of the memory modules of computer 30. Storage device 32 may be used to store information regarding ball grid array patterns 34 and topographical maps 36. Ball grid array patterns 34 may be customized patterns that may be entered by a user using computer 30 or other input devices. Customized patterns may include a subset of the ball grid array pattern 34 on the integrated circuit 22. Ball grid array patterns 34 may also be a standardized set of patterns for common ball grid array devices. Topographical maps 36 may be maps of particular integrated circuits 22. Topographical maps 36 may provide information regarding the height of the material 26 on terminals 24. Topographical maps may be generated using data received from distance measuring device 28. Different integrated circuits 22 may be associated with the same or different ball grid array patterns 34 and topographical maps 36 as each other. Additionally, storage device 32 may store instructions to control computer-aided manufacturing tool 12.

Certain embodiments of ball grid array cleaning system 10 may provide advantages over known techniques for cleaning terminals 24 of ball grid arrays. For example, removal of an integrated circuit 22 from a circuit board typically leaves excess solder, resin, or other debris on material 26 that may hinder its assembly onto another circuit board. Known cleaning techniques for these material 26 include a manual process of removing excess solder using hand tools, such as solder-wicks or solder-suckers. Because ball grid arrays may have numerous terminals 24, this process may present an arduously long task. Thus, the ball grid array cleaning system 10 may be relatively quicker and less labor intensive than these manual techniques for cleaning the material 26 from terminals 24 arranged in a ball grid array in some embodiments.

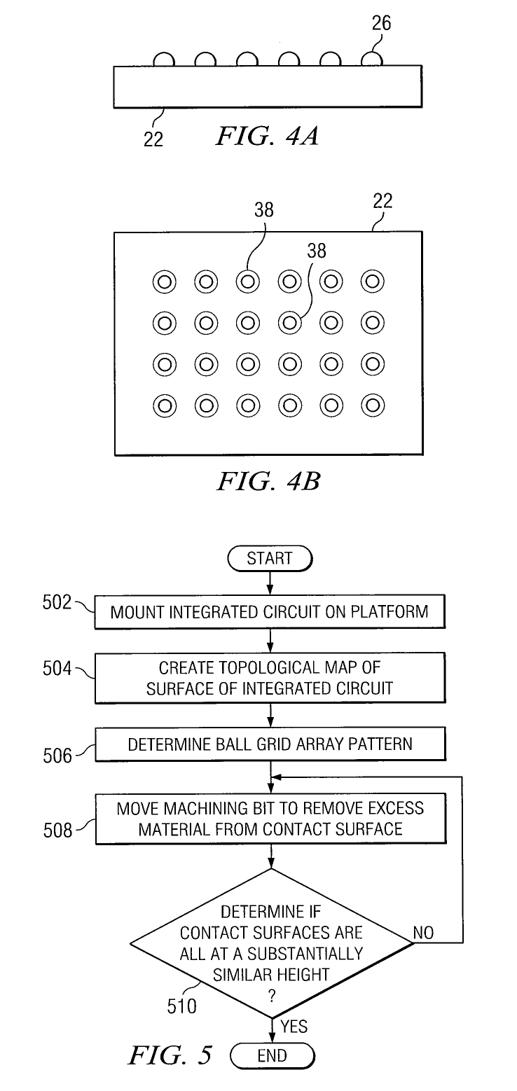

FIGS. 2, 3a, and 3b illustrate views of the ball grid array pattern 34 of an example integrated circuit 22 prior to removal of excess material 26 using ball grid array cleaning system 10. FIGS. 4a and 4b illustrate views of the ball grid array pattern 34 of the example integrated circuit 22 after removal of excess material 26 from terminals 24 to form relatively co-planar electrical connection points. FIG. 5 is a flowchart detailing an example method for carrying out the removal of excess material 26 from a ball grid array pattern 34.

FIG. 2 illustrates a view of a ball grid array pattern 34 of a particular integrated circuit 22. Ball grid array pattern 34 is illustrated as a 6×3 row of terminals 24. Other patterns may be used according to particular embodiments. Common patterns may be already generated and retrieved from storage device 32. Alternatively, new or custom patterns may be entered by a user using computer 30. Custom patterns may include a subset of the terminals 24 on an integrated circuit 22. Custom patterns may be stored in storage device 32 after entry. On each terminal 24 is a ball of solder, resin, or other material 26. This material 26 may be used to adhere the integrated circuit 22 to other components.

FIG. 3a illustrates a side view of a ball grid array on an integrated circuit. Often after depositing, solder, resin, or other material 26 on terminals 24 or after removal of an integrated circuit 22 from a circuit board, the material 26 is not deposited uniformly on terminals 24 leading to uneven material 26. In order to form good electrical connections to other components, the material 26 should be relatively co-planar with one another. Thus, the differing heights of material 26 is not desirable.

FIG. 3b illustrates a topographical map 36 of the ball grid array of FIG. 3a. This topographical map 36 may be created using distance measuring system 28. Distance measuring system 28 may map the height of a number of points on the surface of integrated circuit 22. Contour lines 38 illustrate that both the elevation and shape of material 26 on integrated circuit 22 are not uniform. As described earlier, this hinders assembly of the integrated circuit 22 with other components. The data from the mapping may be sent to computer system 30 for storage and use. The topographical map information may be stored in storage device 32.

In operation of system 10, an integrated circuit 22 is mounted on platform 20. The integrated circuit 22 may have a plurality of terminals 24 with material 26 deposited on each terminal 24. Distance measuring system 28 may measure the distance from a point on computer-aided manufacturing tool 12 to a point on the surface of integrated circuit 22 to create topographical map 36 of the surface of integrated circuit 22. The topographical map 36 data may be transferred to computer system 30 and stored in storage device 32. A user may utilize computer system 30 and enter a customized or choose from a standard ball grid array patterns 34. These patterns may be stored or retrieved from storage device 32. In another embodiment, ball grid array pattern 34 may be generated using data from the topographical map 36. For example, the software in computer system 30 may determine that deviations from a particular elevation represent a terminal 24 that may need to have excess material 26 removed from it.

Once a ball grid array pattern 34 is entered, generated, or chosen, computer system 30 may engage computer-aided manufacturing tool 12. Computer-aided manufacturing tool 12 may cause rotating shank 18 to begin rotating, which in turn causes machining bit 14 to rotate. Computer-aided manufacturing tool 12 may then cause the machining bit 14 to be moved to each of or certain terminals 22 according to the ball grid array pattern 34 and/or the topographical map 36 to remove excess material 26. Alternatively, platform 20 may move with respect to machining bit 14 according to ball grid array pattern 34 and/or topographical map 36. Machining bit 14 may then cause the removal of excess material from material 26.

After removal of material from material 26, another topographical map 36 may be generated by distance measuring system 28. This topographical map 36 may verify that excess material has been removed from the material 26 of terminals 24 such that the side view of the integrated circuit 22 resembles that in FIG. 4a and the topographical map resembles 4b. This process may be repeated until the desired amount of material is removed from material 26.

FIG. 4a illustrates a side view of a ball grid array 34 on an integrated circuit 22 after use of the ball grid array cleaning system 10. As illustrated, material 26 has been reduced to a substantially uniform height on terminals 24. FIG. 4b is a topographical map 36 of the ball grid array 34 of FIG. 4a. As can be seen with contour lines 38, material 26 on each terminal 24 has a substantially similar topographical profile with a relatively uniform height and shape.

FIG. 5 is a flowchart describing a series of actions that may be performed by the ball grid array cleaning system 10. At step 502, an integrated circuit 22 is mounted on platform 20. At step 504, computer-aided manufacturing tool 12 may utilize distance measuring system 28 to create a topographical map 36 of the surface of integrated circuit 22. The topographical map 36 may be used by computer 30 to determine the amount of excess material 26 to remove from terminals 24. At step 506, a ball grid array pattern 34 may be determined for the integrated circuit 22 to be processed. The ball grid array pattern 34 may be entered by a user using computer 30 or be one of a number of predetermined patterns stored on storage device 32. At step 508, computer 30 may control computer-aided manufacturing tool 12 to begin rotation of machining bit 14. Computer 30 may cause computer-aided manufacturing tool 12 to move machining bit 14 to one or more of the plurality of terminals 24 to remove excess material 26. At step 510, distance measuring system 28 may create another topological map 36 of the surface of integrated circuit 22. If material 26 are all substantially at the desired height, the method ends. If the material 26 are still at different heights or more material 26 needs to be removed, the process may return to step 508 to have machining bit 14 remove more excess material 26 from terminals 24.

Although several embodiments have been illustrated and described in detail, it will be recognized that substitutions and alterations are possible without departing from the spirit and scope of the present disclosure, as defined by the following claims.

What is claimed is:

1. A computer aided manufacturing tool, comprising:
a platform upon which an integrated circuit is mounted, wherein the integrated circuit has a plurality of terminals arranged in a ball grid array pattern on a surface of the integrated circuit;
a machining bit;
a computer system that:
stores the ball grid array pattern and a topographic map of the surface of the integrated circuit; and
controls the machining bit such that the machining bit removes excess material from the plurality of terminals based at least in part upon the ball grid array pattern and the topographical map.

2. The system of claim 1, further comprising
a laser for measuring the distance from the machining bit to a plurality of points on the surface of the integrated circuit.

3. The system of claim 2, wherein the computer system is further operable to receive information regarding the distance from the machining bit to the plurality of points on the surface of the integrated circuit.

4. The system of claim 3, wherein the computer system creates a topographic map of the surface of the integrated circuit from the received information.

5. The system of claim 1, wherein the computer system is operable to receive user input regarding a subset of the plurality of terminals for which excess material should be removed.

6. The system of claim 1, wherein the computer system is further operable to cause the machining bit to move to each of the plurality of terminals to remove excess material from each of the plurality terminals to achieve a substantially uniform height among the plurality of terminals.

7. The system of claim 1, wherein the machining bit is coupled to a rotating shaft of the computer aided manufacturing tool.

8. The system of claim 1, wherein the excess material comprises solder.

9. A method, comprising:
receiving an integrated circuit on a platform coupled to a manufacturing tool, wherein the integrated circuit has a plurality of terminals arranged in a ball grid array pattern on a surface of the integrated circuit, and wherein the manufacturing tool further comprises a machining bit that is movable with respect to the platform;
storing the ball grid array pattern and a topographic map of the surface of the integrated circuit in a computer system that controls the manufacturing tool;
moving the machining bit, such that the machining bit removes excess material from the plurality of terminals based at least in part upon the ball grid array pattern and the topographical map.

10. The method of claim 9, further comprising:
creating the topographic map of the surface of the integrated circuit, wherein the topographic map comprises information regarding the height of material on the surface of the integrated circuit.

11. The method of claim 10, wherein the topographic map is created using a laser system.

12. The method of claim 9, further comprising;
creating a customized ball grid array pattern for storage at the computer system based at least in part on the topographic map.

13. The method of claim 9, further comprising:
determining a distance between the surface of the integrated circuit and the tip of the machining bit to create the topographic map.

14. The method of claim 9, further comprising:
removing excess material from each of the plurality of terminals to achieve a substantially uniform height of materials among the plurality of terminals.

15. The method of claim 9, further comprising:
receiving user input regarding a subset of the plurality of terminals at the computer system;
removing excess material from the subset of the plurality of terminals according to the user input.

16. The method of claim 9, further comprising, providing an interface for a user to enter information regarding a custom ball grid array pattern.

17. A device, comprising:
a computer aided manufacturing tool comprising a platform and a machining bit that is movable with respect to the platform;
wherein the platform is operable to temporarily mount an integrated circuit, the integrated circuit having a plurality of terminals arranged in a ball grid array pattern on a surface of the integrated circuit;
wherein the computer aided manufacturing tool is operable to receive information regarding a ball grid array pattern and a topographical map of the surface of the integrated circuit; and
wherein the machining bit is operable to remove excess material from the plurality of terminals based at least in part upon the ball grid array pattern and the topographical map.

18. The device of claim 17, wherein the computer aided manufacturing tool is operable to generate topographic information of the surface of the integrated circuit, the topographic map comprising information regarding the height of material on the surface of the integrated circuit.

19. The device of claim 18, wherein the topographic map is generated using a laser measuring system.

20. The device of claim 17 wherein the computer aided manufacturing tool is operable to remove excess material from the plurality of terminals to achieve a substantially uniform height of materials among the plurality of terminals.
